(19) United States
(12) Patent Application Publication
(10) Pub. No.: US 2008/0150247 A1
(43) Pub. Date: Jun. 26, 2008

(54) DETACHABLE CONNECTING DEVICE FOR A CHILD CARRIER

(75) Inventor: Jon Lake, Sunnyvale, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: iLinko Ltd., Quarry Bay (HK)

(21) Appl. No.: 11/942,694

(22) Filed: Nov. 19, 2007

(30) Foreign Application Priority Data
Nov. 17, 2006 (DE) 20 2006 017 551.2

(51) Int. Cl. F16B 17/00; B62B 9/12

(52) U.S. Cl. 280/47.41; 403/345

(57) ABSTRACT

A connecting device for detachably connecting a first and second component of a people carrier comprises a locking unit with a first locking element that interacts with the first component, a second locking element that interacts with the second component, and at least one actuation device. The locking unit comprises a locking position in which the first and second locking elements mechanically engage each other, and an unlocking position in which the mechanical grip is released. The first and/or second locking elements are moveable by the actuation device to transfer the locking unit into the locking and/or unlocking position. The actuation unit may comprise first and second actuation devices that, when actuated, cause the first and/or second locking element to move from a locking position into an unlocking position, or vice-versa. The first and second actuation devices can be actuated from different sides of the connecting device.

### BACKGROUND

A number of child carriers are known in the prior art, in particular in the form of perambulators.

U.S. Pat. No. 6,446,900 B1, for example, discloses a transport vehicle for a small child. The transport vehicle comprises a frame onto which a child carrier basket can be affixed in such a manner that it can be detached. In order to lock the carrier basket onto the frame, the carrier basket comprises a rod onto which a locking mechanism that is arranged on the frame can grip. For this purpose, the locking mechanism is supported in such a manner that it can be pivoted, and comprises recesses in order to retain the rod in a locking position of the locking device.

Furthermore, U.S. Pat. No. 6,286,844 B1 discloses a perambulator with a detachable seat. This perambulator contains a frame and a perambulator seat, which can be coupled to the frame by means of a generic connecting device. In order to lock the seat to the frame, the seat comprises a retaining pin which can grip into a hook of a locking device which interacts with the frame. In order to be able to release the hook grip on the pin, the seat comprises a release button which interacts with the hook when the seat is affixed to the frame. In order to unlock the seat from the frame, the release button is pressed down, as a result of which the grip of the hook in the pin is released.

DE 299 23 625 U1 discloses a buggy comprising a frame and a seat which is affixed to said frame. Via a plug-in and socket connection, the seat can be attached to the frame both in the direction of travel of the buggy and in the opposite direction. In addition, an angle of inclination of the otherwise static seat can be set relative to the frame via a joint.

However, a disadvantage of the locking devices for perambulators known in the prior art is that their operation is impeded depending on the operating position of the perambulator. In particular, with perambulators having a child carrier device that can be arranged both in the direction of travel and against the direction of travel, an actuation device for a locking unit may be covered by other elements of the perambulator, such as frame elements, and thus be difficult to operate by a user. Frequently, unsuitable lever forces also impede ergonomically acceptable operation.

In addition, perambulators in the prior art are known to have a child carrying device that can be converted from a seating configuration into a cot or basket configuration.

For example, a combination of a perambulator and a child carrying device is disclosed in U.S. Pat. No. 4,836,573. This combination comprises a frame of the perambulator and a child carrying device which is attached to the frame in a pivoted manner. In order to convert the child carrying device from a basket configuration, in which the child carrying device is essentially cuboid, into a seat configuration, said child carrying device is first pivoted in such a manner that a side wall of the child carrying device forms a seat surface, while a floor surface of the child carrying device adopts the function of a backrest. The additional three side walls of the child carrying device take the form of flexible side walls, so that the child carrying device can be converted from the cuboid form into a wedge form. However, the disadvantage with this combination is that the seat configuration is not very comfortable for a child.

U.S. Pat. No. 5,833,261 discloses a footrest for a perambulator which can be moved between two positions. The perambulator comprises a frame onto which elements are affixed which enable the frame to retain a child carrying device in the form of a seat on the one hand, and in the form of a basket or cot on the other. For this purpose, on the one hand, a frame element which creates a backrest can be pivoted in such a manner that an angle between this element and an element which supports a seat surface can be altered. However, a disadvantage with this perambulator is that the frame cannot be adapted to different seating configurations. In particular, an angle of inclination of the seat surface cannot be altered.

### SUMMARY

It is therefore an object of the present disclosure to provide a person carrying device for a people carrier that overcomes the disadvantages of the prior art and, in particular, is easy to operate in any configuration of the people carrier. Furthermore, the present disclosure provides a people carrier, for example in the form of a perambulator or stroller, that overcomes the disadvantages of the prior art. The term “people carrier” as used herein should be understood to broadly include any form of vehicle capable of carrying a person of any age. The term “child carrier” is used herein synonymously with “people carrier” because such vehicles are typically used to transport children, though forms of such vehicles may be used to carry other persons of other ages, including those who are unable to transport themselves on foot. In various exemplary styles, a child carrier may be in the form of a perambulator or pram, a baby carriage, a carrycot, a stroller, a push chair, a buggy, etc.

In various embodiments, disclosed herein is a connecting device for the detachable connection of at least one first component and at least one second component of a child carrier. In at least one embodiment, the connecting device comprises at least one locking unit with at least one first locking element which interacts with the first component, at least one second locking element which interacts with the second component, and at least one actuation device. The locking unit comprises at least one locking position, in which the first locking element and the second locking element mechanically engage each other, and at least one unlocking position in which the mechanical engagement is released. The first and/or the second locking element is or are moveable by means of the actuation device in order to transfer the locking unit into the locking position and/or into the unlocking position. Furthermore, disclosed herein is a child carrier, for example, in the form of a perambulator or stroller, comprising a connecting device of the type described above.

In at least one embodiment, an actuation unit comprises at least one first actuation device and at least one second actuation device. When the first actuation device and/or the second actuation device is actuated, the first locking element can be moved equally from a locking into an unlocking position, or vice-versa, and/or when the first actuation device is actuated and/or when the second actuation device is actuated, the second locking element can be moved equally from a locking position into an unlocking position, or vice-versa.

Here, of particular advantage is an embodiment with which the first and the second actuation device can be actuated from different, potentially opposite sides of the connecting device.

Furthermore, in various embodiments the first component and/or the second component comprises at least one part of at least one frame of the child carrier, at least one part of at least one child carrying device, such as at least one seat, at least one cot, at least one basket, at least one wheel, at least one wheel carrier, at least one handle, at least one push rod, and/or at least one part of an additional child carrying device, such as at least one auxiliary seat, and/or at least one treadboard, and/or at least one, preferably fold-in, canopy top, in particular in the form of a covering hood, a canopy, a roof span, a marquise, a screen, and/or a hood.

With the aforementioned alternatives, there may also be provided at least one first force generating unit, for example comprising at least one spring unit, by way of which the first locking element can be forced into at least one locking position or at least one unlocking position. There may also be provided at least one second force generating unit, for example comprising at least one spring unit, by way of which the second locking element can be forced in at least one locking position or at least one unlocking position. For example, the force generating unit can be set in such a manner that a force of at least 50 N is required in order to activate the locking or unlocking mechanism.

It is furthermore disclosed herein that the first component and the first locking element and/or the second component and the second locking element may be formed of a single piece, at least in sections. Preferably, the first locking element and/or the second locking element on the one hand, and the first actuation device and/or the second actuation device on the other hand, are formed of a single piece, at least in sections.

A connecting device as described herein can also be characterized in that the first locking element or the second locking element is moveably supported, in particular by way of the first and the second actuation device, wherein preferably, the second or the first locking element is essentially affixed at a fixed position at least indirectly to the second or the first component and/or is formed within said component at a fixed position.

It is furthermore disclosed herein that the first locking element or the second locking element may be supported around at least one rotational axis in such a manner that it can be pivoted, wherein in particular both by way of the first actuation device and by way of the second actuation device, an equal torque on the first or the second locking element can be applied.

A particularly advantageous embodiment provides that the first locking element and the second locking element comprise, at least in sections, surface forms which are complementary to each other. For example, the first locking element and/or the second locking element may comprise at least one catch hook, at least one latch hook, at least one rod, and/or at least one pin.

It is finally preferred for a connecting device as described herein that the first actuation device and the second actuation device are each designed in the form of at least one longitudinally moveable element, wherein one end of the respective element at least at certain times engages the first locking element or the second locking element.

Furthermore, disclosed herein is a child carrier comprising at least one first component and one second component, wherein both components are detachably connectable with each other via at least one connecting device as described herein.

The child carrier may further comprise at least one child carrying device, wherein the child carrying device comprises at least one frame and can be converted from a seat configuration in which the child can be supported in an essentially sitting position into a basket configuration in which the child can be supported in an essentially lying position and/or vice-versa. The angle of inclination of at least one first frame component, which creates at least one backrest in the seat configuration, is adjustable relative to at least one main frame of the child carrier via at least one first turning unit. The frame may further comprise at least one second frame component that creates at least one seat surface in the seat configuration, wherein at least one angle between the first and the second frame component is adjustable independently of the first turning unit via a second turning unit which connects the first and the second frame component.

With the aforementioned alternatives, the frame may further comprise at least one third frame component which preferably creates a footrest, wherein the second and third frame component are connected with each other via at least one third turning unit, and wherein, at least one angle is adjustable between the second and the third frame component.

Furthermore, the child carrier may comprise a bracket which is detachable, connectable, and/or formed as a single piece, at least in sections, with the first and/or the second frame component, wherein the bracket can preferably be used in the seat configuration as a safety bracket and/or can be used in the basket configuration as a carrying handle.

In one advantageous embodiment, the frame is affixable to the main frame by way of at least one connecting device as disclosed herein, in particular in a detachable manner.

While embodiments are described herein in the context of a child carrier, such as a perambulator or stroller, the invention is not limited to the precise forms disclosed. The principles of the invention described and claimed herein may equally be applied to a sports vehicle, a buggy, a perambulator for the transportation of at least two children, a disabled person's buggy, and/or a disabled person's vehicle, among other forms of vehicles for carrying people of any age.

As shown herein, a connecting device for connecting two components of a child carrier, such as a perambulator or stroller, can be designed in such a manner that a lock between the two components in the different configurations of the child carrier, in particular, a lock of a child carrying device such as a child's seat, is made possible in different positions of the child carrying device, particularly in the direction of travel and/or against the direction of travel of the child carrier. The locking device comprises at least two operating elements arranged at different positions of the connecting device, wherein an actuation of the actuation devices leads to an equal movement on the same locking element of the connecting device. This means that regardless of whether the first or the second actuation device is actuated, the locking element can be moved in the same direction in order to transfer the connecting device from a locking position into an unlocking position, or vice-versa. This makes it possible to arrange the actuation device on the connecting device in such a manner that at least one of the actuation devices can be actuated by a user in any configuration required of the people carrier, in order to lock or unlock the connecting device.

### DESCRIPTION OF THE DRAWINGS

Further features and advantages of the invention are described below using examples, in which the exemplary embodiments of the invention are explained with reference to schematic drawings, in which:

FIG. 1 shows a perambulator according to one embodiment of the invention with a main body and a child carrying device;

FIG. 2 shows the perambulator shown in FIG. 1, wherein the child carrying device is covered with corresponding textile elements, and further comprises a canopy top;

FIG. 3 shows an enlarged detailed view of the portion A of FIG. 1, in which a connecting device according to one embodiment of the invention is shown;

FIG. 4a shows a cross-sectional view of the connecting device shown in FIG. 3 in a locked position;

FIG. 4b shows a cross-sectional view of the connecting device shown in FIG. 3 in an unlocked position;

FIG. 4c shows a cross-sectional view of the connecting device shown in FIG. 3 in an unlocked position;

FIG. 5 shows a perspective view of the perambulator in FIG. 1 following a release of the connection between the child carrying device and the main body;

FIG. 6 shows a side view of the perambulator shown in FIG. 1, in which the child carrying device is in a seat configuration;

FIG. 6b shows a side view of the perambulator shown in FIG. 6a after the child carrying device has been pivoted around a first rotational axis for transfer into a basket configuration;

FIG. 6c shows a side view of the perambulator shown in FIG. 6b in which a component of the child carrying device is pivoted around a second rotational axis for transfer into a basket configuration;

FIG. 6d shows a side view of the perambulator shown in FIG. 6c in which a component of the child carrying device has been pivoted around a third rotational axis for transfer into a basket configuration;

### DETAILED DESCRIPTION

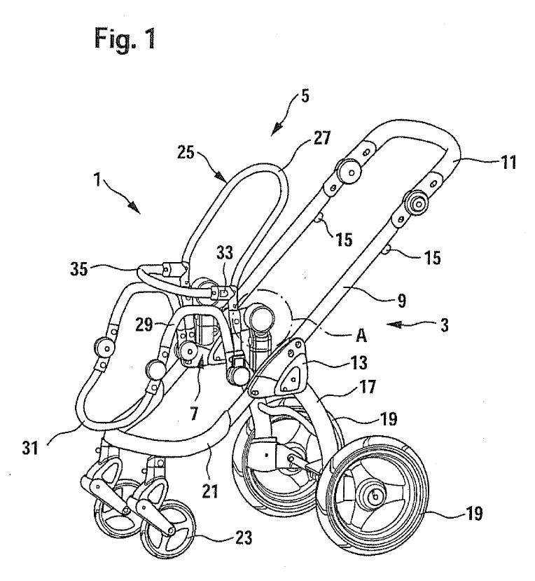

FIG. 1 shows a perspective view of a people carrier or child carrier in the form of a perambulator 1. The perambulator 1 comprises a main body or frame 3 and a person carrying device in the form of a child carrying device 5. Here, it should be noted that in FIG. 1, only a basic form of the child carrying device 5 is shown. The child carrying device 5 is detachably connected to the frame 3 via a connecting device.

The frame 3 comprises for example a push rod 9 with a handle 11. Via a folding mechanism 13, which can be unlocked via a release lever 15, the push rod 9 is connected with a rear wheel carrier 17 on which rear wheels 19 are attached, and a front wheel carrier 21 to which front wheels 23 are applied. The child carrying device 5 comprises, as will be explained in greater detail below, a frame 25, which comprises a first frame component 27, a second frame component 29, and a third frame component 31.

In FIG. 1, the child carrying device 5 is in a seat configuration in which the first frame component 27 essentially creates a backrest, the second frame component 29 essentially creates a seat surface or a side guide element or an armrest for a child which is positioned in the child carrying device 5, and the third frame component 31 creates a footrest. As can be seen from FIG. 1, a bracket 35 can be detachably affixed to the frame 25 by means of a connecting unit 33. This bracket 35 prevents the child from falling out of the child carrying device 5 in the seat configuration shown in FIG. 1. In other words, the bracket 35 acts as a safety bracket, while the bracket 35, as will be explained in greater detail below, can also be used in a basket configuration of the child carrying device 5 as a carrying bracket.

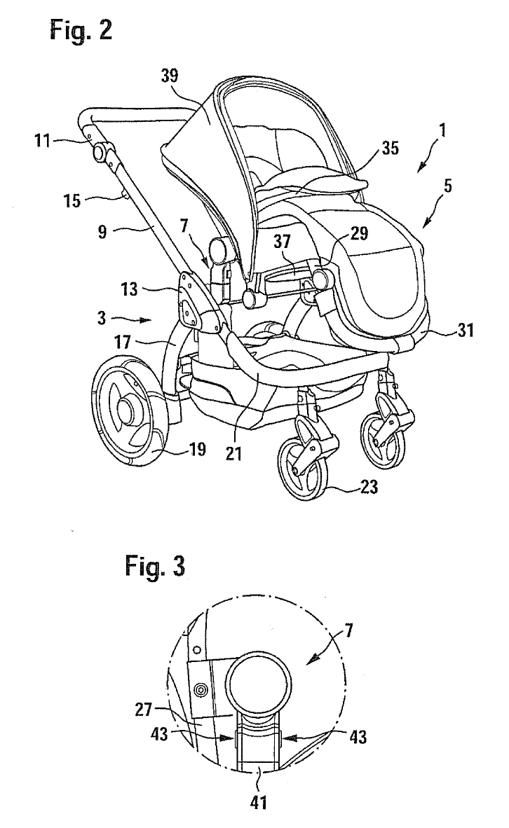

FIG. 2 shows a side view of the perambulator 1 shown in FIG. 1. In contrast to FIG. 1, the frame 25 of the child carrying device 5 is covered with a fabric cover 37. As a result, a corresponding seat surface and backrest is provided for a child to be positioned in the child carrying device 5. Here, it should be noted that although in FIG. 2, the frame 25 is covered with a textile material, the invention is not restricted to this embodiment. In particular, essentially fixed or inflexible elements, such as hard shell elements, can alternatively be attached to the frame 25, in particular the frame components 27, 29, 31, in order to provide a backrest, a seat surface, and/or a footrest. Furthermore, in FIG. 2, a canopy top 39, which in FIG. 2 is in a folded-in state, can be arranged on the child carrying device 5.

The structure and functionality of the connecting device 7 will now be explained in detail below. Although in the embodiment shown, the connecting device 7 is used to connect the child carrying device 5 to the frame 3, the present invention is not restricted to this specific application. Thus, by means of the connecting device 7 shown or equivalents thereto, different components of a people carrier, such as perambulator 1, can be detachably connected with each other. Thus for example, using a connecting unit 33 that comprises the features of the connecting device 7, the canopy top 39 could be connected by way of a corresponding connecting device to the child carrying device 5, or further components such as an auxiliary seat or a treadboard could be connected to the frame 3 by way of such a connecting device.

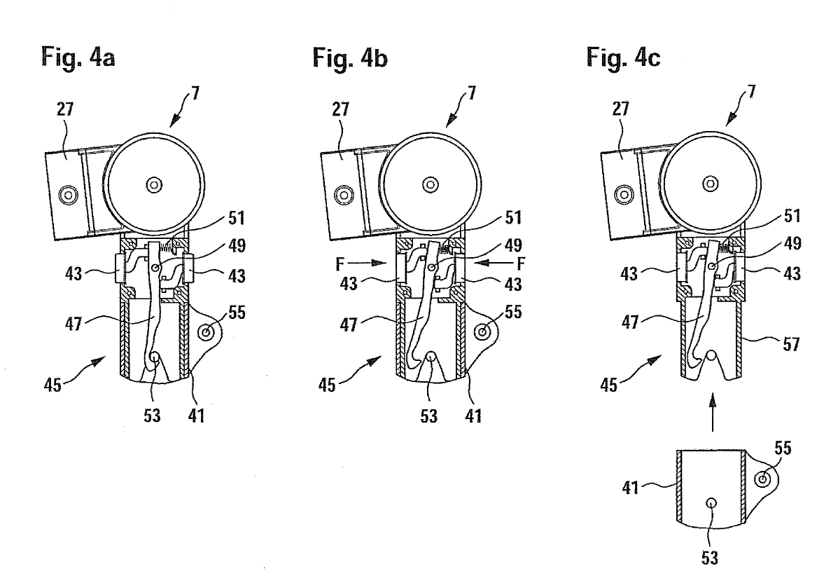

As can be seen in FIGS. 1 and 3, the connecting device 7 is used in the embodiment shown in order to detachably connect the child carrying device 5 by way of the first frame component 27, to the frame 3 by way of a connecting element 41. In order to prevent the child carrying device 5 from inadvertently becoming detached from the frame 3, the connecting device 7 comprises a locking unit 45 which will subsequently be described in greater detail. The locking unit 45 comprises actuation devices in the form of two push-buttons 43, wherein a first actuation device is arranged in a direction of travel of the child carrier, while the second actuation device is arranged against the direction of travel. As a result of an actuation or pressing down of at least one of the push-buttons 43, the locking unit 45 can be transferred from a locking position to an unlocking position. If the locking unit 45 is in an unlocking position, the child carrying device 5 can be detached from the frame 3.

The perambulator 1 shown in FIG. 1 comprises two connecting devices 7, with one respectively on each side of the child carrying device 5. Here, both connecting devices 7 comprise a corresponding locking unit 45. In an alternative embodiment, only one of the connecting devices 7 comprises a corresponding locking unit 45.

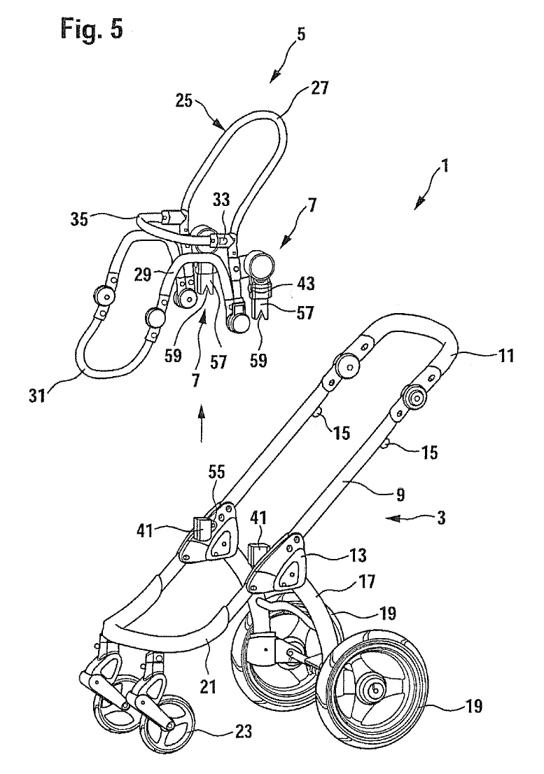

FIG. 4a shows a cross-section view through the connecting device 7 shown in FIG. 3. The connecting device 7 comprises a locking unit 45. The locking unit 45 comprises a first locking element in the form of a latch hook 47. The latch hook 47 is supported around an axis 49 in such a manner that it can be pivoted. Furthermore, the locking unit 45 comprises a force generation unit in the form of a spring unit 51. Via the spring unit 51, the latch hook 47 is forced into the position shown in FIG. 4a. The locking unit 45 furthermore comprises a second locking element in the form of a pin 53. The pin 53 is designed as a single piece with the connecting element 41, which is connectable with the frame 3 by way of a screw connection 55. In the configuration shown in FIG. 4a, the locking unit 45 is in a locking position. In particular, the latch hook 47 engages with the pin 53 so that the child carrying device 5 cannot be detached from the connecting element 41.

In order to remove the child carrying device 5 from the frame 3, the locking unit 45 is transferred to an unlocking position, as it is shown in particular in FIG. 4b. In order to transfer the locking unit 45 into the unlocking position, the latch hook 47 is transferred from the locking position shown in FIG. 4a to the unlocking position shown in FIG. 4b, in which it no longer engages the pin 53. For this purpose, one of the push-buttons 43 is subjected to a force F by a user, as a result of which the latch hook 47 revolves around the axis 49 against the force of the spring unit 51. Although, as is shown in FIG. 4b, both push-buttons 43 can be pressed down simultaneously, for a transfer of the locking unit 45 from the locking position into the unlocking position, an actuation of just one push-button 43 is sufficient. Thus, a single actuation of one of the push-buttons 43, regardless which push-button 43 is actuated, leads to an identical or equal movement of the latch hook 47, i.e., to a revolution of the latch hook 47 around the axis 49 shown in FIG. 4a and FIG. 4b in a clockwise direction.

The child carrying device 5 is designed in such a manner that it is possible to arrange the child carrying device 5 in the direction of travel and against the direction of travel of the perambulator 1. Due to the geometry of the frame 3 and different additional elements which can be attached to the frame 3 and the child carrying device 5, it can be the case that one of the actuation devices or push-buttons 43 is not easily accessible to the user, while the other push-button 43 is easily accessible. The locking unit 45 thus has an advantage that an uncomplicated unlocking of the locking device 7 is possible in every configuration of the perambulator 1. This is achieved by way of the fact that the actuation devices mechanically interact with one of the locking elements, in this case, with the first locking element in the form of the latch hook 47, in such a manner that an actuation of one of the actuation devices leads to a movement of the locking element in the same direction, regardless of the actuation device in question.

Following a transfer of the locking unit 45 into an unlocking position, the child carrying device 5 can be detached from the frame 3. As can be seen in FIG. 4c, for this purpose, a shaft 57 is pulled out of the connecting element 41. In particular, in order to achieve a state in which the pin 53 is set in a specified position relative to the latch hook 47, when the child carrying device 5 is attached to the frame 3, the shaft 57 essentially comprises a V-shaped recess 59, into which the pin 53 slides when the shaft 57 is inserted into the connecting element 41.

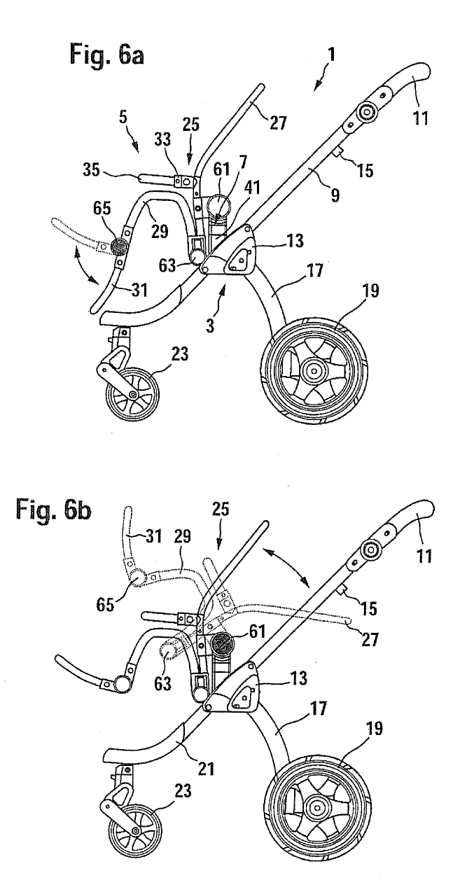

FIG. 5 shows the perambulator 1 shown in FIG. 1, after the connection between the child carrying device 5 and the frame 3 has been released by actuating the connecting device 7 and by lifting the child carrying device 5.

In the following, options for positioning the child carrying device 5 will be explained, in order to illustrate the variability of the child carrying device 5. In particular, it will be explained how the child carrying device 5 can be converted from a seat configuration as shown in FIG. 1 to a basket or cot configuration.

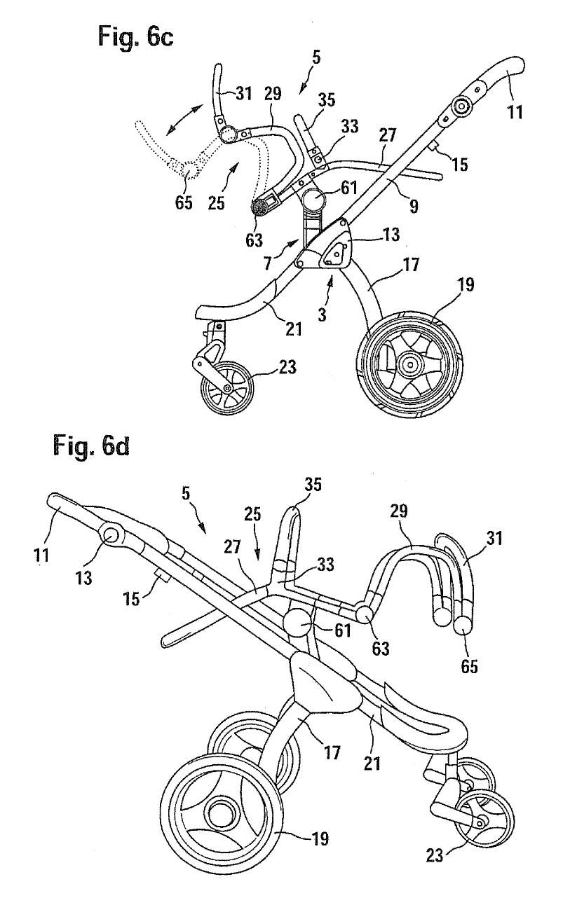

As can be seen in FIG. 6a, the child carrying device 5 comprises a first turning unit 61, by way of which the first frame component 27 is connected with the frame 3 by way of the connecting device 7 in such a manner that it can be pivoted. By way of the first turning unit 61, an angle can be set between the frame 3 and the first frame component 27. Alternatively, an angle can be set between the frame 3 and the entire child carrying device 5. The angle can be adjusted continuously or the angle can be altered in discrete stages via the turning unit 61. In particular, the first turning unit 61 can comprise different latch positions for this purpose, in which the first turning unit 61 can preferably be set in a desired position.

The second frame component 29 is connected to the first frame component 27 via a second turning unit 63. The second turning unit 63 makes it possible to alter an angle between the first frame component 27 and the second frame component 29 continuously and/or in discrete stages. In the seat configuration of the child carrying device 5 shown in FIG. 6a, the first frame component 27 essentially creates a backrest (not shown), while the second frame component creates a seat surface (not shown). The backrest and seat surface are produced by attaching a textile covering or corresponding seat shell components to the frame 25. In this manner, the second turning unit 63 makes it possible to set an angle between the backrest and the seat surface in the seat configuration shown in FIG. 6a.

Finally, the third frame component 31 which acts as a footrest is connected to the second frame component 29 via a third turning unit 65. In the seat configuration shown in FIG. 6a, the third turning unit 65 enables a continuous setting and/or a setting in discrete stages of a footrest relative to the seat surface which is created by the second frame component 29. Thus, the feet of a child sitting in the child carrying device 5 can be either raised up or left hanging down. Preferably, at least one of the turning units 61, 63, 65 comprises at least one operating element, by means of which the corresponding turning unit 61, 63, 65 can be locked in a desired position, or a corresponding lock can be modified in order to adjust the relative positions of the frame components 27, 29, 31 to each other, or to adjust the frame 25 to the frame 3 of the perambulator 1.

It will now be explained below how the child carrying device 5 can be converted from the seat configuration shown in FIG. 6a into a cot or basket confirmation. According to FIG. 6b, for this purpose, the frame 25 of the child carrying device 5 is initially tipped relative to the frame 3 of the perambulator 1 by way of the first turning unit 61. In particular, a backrest created by the first frame component 27 is brought into a position which is substantially parallel to a surface on which the perambulator 1 is arranged.

As a result of a subsequent actuation of the second turning unit 63, the second frame component 29 can then, for example, be pivoted, together with the third frame component 31, relative to the first frame component 27, as is shown in FIG. 6c. In particular, the frame 25 can in this manner be brought into a configuration in which a surface of the backrest created by the first frame component 27 is positioned at an angle of 180° to the seat surface created by the second frame component 29, so that a lying surface is formed for a child carried in the child carrying device.

Finally, the third frame component can then be adjusted relative to the second frame component 29 via the third turning device 65, in order complete the basket configuration as shown in FIG. 6d.

Thus, the child carrying device 5 makes it possible to provide maximum flexibility at the highest possible degree of comfort for a child carried in the child carrying device or for a user. The first turning unit 61 enables a complete tipping of the child carrying device 5, in particular when said child carrying device is in a seat configuration shown in FIG. 6a, but also when the child carrying device is in the basket or cot configuration shown in FIG. 6d. In addition, the second turning unit 63 makes it possible, in particular when the child carrying device 5 is in the seat configuration, to set an angle between a backrest and a seat surface of the child carrying device 5. Finally, the third turning unit 65 makes it possible to adapt a footrest for use in a desired position, and at the same time for it to act as an end wall for the child carrying device 5 in a basket configuration. As can be seen in particular in FIG. 6d, the bracket 35 of the child carrying device 5 can be used in the basket configuration of said device as a carrying handle, in particular in order to lift the child carrying device 5 from the frame 3 after unlocking the connecting device 7.

As can be seen in particular in FIG. 2, in an advantageous embodiment of the perambulator 1, it is provided that the child carrying device 5 further comprises a canopy top 39.

The features of the invention disclosed in the above description, in the claims and in the drawings can in their different embodiments be present both individually and in any combination required in order to realize the invention.

While illustrative embodiments have been illustrated and described, it will be appreciated that various changes can be made therein without departing from the spirit and scope of the invention.

What is claimed is:

1. A connecting device for the detachable connection of at least one first component and at least one second component of at least one people carrier, the connecting device comprising:
at least one locking unit with at least one locking element that interacts with the first component;
at least one second locking element that interacts with the second component; and
at least one actuation device,
wherein the locking unit comprises at least one locking position in which the first locking element and the second locking element mechanically engage each other, and at least one unlocking position in which the mechanical grip is released,
wherein the first and/or the second locking element is or are moveable by the actuation device in order to transfer the locking unit into the locking position and/or the unlocking position,
wherein the actuation unit comprises at least one first actuation device and at least one second actuation device, and when the first actuation device is actuated and/or when the second actuation device is actuated, the first locking element is moveable equally from a locking position into an unlocking position, or vice-versa, and/or when the first actuation device is actuated and/or when the second actuation device is actuated, the second locking element is equally moveable from a locking position into an unlocking position, or vice-versa.

2. A connecting device according to claim 1, wherein the first and the second actuation device can be actuated from different sides of the connecting device.

3. A connecting device according to claim 1, wherein the first and the second actuation device can be actuated from opposite sides of the connecting device.

4. A connecting device according to claim 1, wherein the first component and/or the second component comprises at least one part of at least one frame of the people carrier, at least one part of at least one person carrying device, at least one part of an additional person carrying device, at least one treadboard, at least one canopy top, a canopy, a roof span, a marquise, a screen, and/or a hood.

5. A connecting device according to claim 1, further comprising at least one first force generating unit configured to force the first locking element into at least one locking position or at least one unlocking position, and/or at least one force generating unit configured to force the second locking element into at least one locking position or at least one unlocking position.

6. A connecting device according to claim 1, wherein the first component and the first locking element and/or the second component and the second locking element are formed of a single piece, at least in sections.

7. A connecting device according to claim 1, wherein the first locking element and/or the second locking element on the one hand and the first actuation device and/or the second actuation device on the other hand are formed of a single piece, at least in sections.

8. A connecting device according to claim 1, wherein the first locking element or the second locking element is moveably supported by the first and the second actuation device, wherein the second or the first locking element is affixed at a fixed position at least indirectly to the second or the first component and/or is formed within said component at a fixed position.

9. A connecting device according to claim 1, wherein the first locking element or the second locking element is configured to pivot around at least one rotational axis, and wherein both the first actuation device and the second actuation device can apply an equal torque on the first or on the second locking element.

10. A connecting device according to claim 1, wherein the first locking element and the second locking element comprise, at least in sections, surface forms that are complementary to each other and/or the first locking element and/or the second locking element comprises or comprise at least one catch hook, at least one latch hook, at least one rod, and/or at least one pin.

11. A connecting device according to claim 1, wherein the first actuation device and the second actuation device are each comprised of at least one longitudinally moveable element, and wherein one end of the respective element at least at certain times engages with the first locking element or with the second locking element.

12. A people carrier comprising at least one first component and one second component, wherein both components are detachably connectable to each other via at least one connecting device according to any one of claims 1 to 11.

13. A people carrier according to claim 12, comprising at least one person carrying device for the people carrier, wherein the person carrying device comprises at least one frame and is convertible from a seat configuration in which a person is supported in a substantially sitting position into a basket configuration in which the person is supported in a substantially lying position and/or vice-versa, wherein an angle of inclination of at least one first frame component which creates at least one backrest in the seat configuration relative to at least one main frame of the people carrier is adjustable via at least one first turning unit, wherein the frame comprises at least one second frame component which creates at least one seat surface in the seat configuration, and wherein at least one angle between the first and the second frame component is adjustable independently of the first turning unit via a second turning unit that connects the first and the second frame component.

14. A people carrier according to claim 13, wherein the frame is affixable in a detachable manner to the main frame via at least one connecting device according to any one of claims 1 to 11.

15. A people carrier according to claim 12, wherein the people carrier is provided in the form of a perambulator or in the form of at least one sports vehicle, at least of one buggy, at least of one perambulator for the transportation of at least two children, at least one disabled person's buggy, and/or at least one disabled person's vehicle.
